(19) United States
(12) Patent Application Publication
(10) Pub. No.: US 2007/0266369 A1
(43) Pub. Date: Nov. 15, 2007

(54) METHODS, SYSTEMS AND COMPUTER PROGRAM PRODUCTS FOR RETRIEVAL OF MANAGEMENT INFORMATION RELATED TO A COMPUTER NETWORK USING AN OBJECT-ORIENTED MODEL

(76) Inventors: Jiebo Guan, Missouri City, TX (US); Garve Hays, Cypress, TX (US); Richard Giles, Houston, TX (US)

Correspondence Address: MYERS BIGEL SIBLEY & SAJOVEC, PO BOX 37428, RALEIGH, NC, 27627, US

(21) Appl. No.: 11/744,991

(22) Filed: May 7, 2007

Related U.S. Application Data
(60) Provisional application No. 60/799,540, filed on May 11, 2006.

(51) Int. Cl. G06F 9/44

(52) U.S. Cl. 717/116; 717/165

(57) ABSTRACT

Methods, systems and computer program products are provided for retrieval of management information related to a computer network using an object-oriented information model. A plurality of resource classes are provided, instances of which represent a resource on the computer network. Ones of the classes have respective associated attributes. A plurality of association classes are also provided, instances of which represent a relationship between ones of the resource class instances. A query for retrieval of management information is received from a user. The query includes an identification of a first one of the resource classes and a second one of the resource classes and a selected one of the association classes. Instances of the first and/or second ones of the resource classes identified by instances of the selected one of the association classes are retrieved responsive to the received query and an identification of the retrieved instances of the first and/or second ones of the resource classes is provided to the user.

### RELATED APPLICATION

This application claims the benefit of and priority to U.S. Provisional Patent Application No. 60/799,540, entitled “METHODS, SYSTEMS AND COMPUTER PROGRAM PRODUCTS FOR MANAGING INFORMATION TECHNOLOGY(IT) RESOURCES,” fired May 11, 2006, the disclosure of which is hereby incorporated herein by reference as if set forth in its entirety.

### BACKGROUND OF THE INVENTION

The present invention, generally, relates to computer networks and, more particularly, to methods, systems and computer program products for managing such computer networks.

In today's disparate information technology world, object-oriented information models, such as the Common Information Model (CIM) by Distributed Management Task Force (DMTF) and the NetIQ Common Information Model (IQCIM) by NetIQ Corporation, have become increasingly more critical in enabling different management products from different vendors to exchange semantically rich management information via computer networks. The CIM Query Language (CQL) Specification is discussed at world wide web address dmtg.org/standards/published_documents/DSP0202.pdf.

Object-oriented common information models, such as CIM and IQCIM, represent managed IT resources and their aggregate functions/services having discrete object classes and associations. Objects indicate the existence of the resources and aggregate functions and describe the properties of them. Associations describe the logical relationships between the objects, such as a computer is being used for an IT service.

Furthermore, as managing IT resources becomes increasingly more important, it may be common for a company to utilize multiple management point products to manage its IT resources. In an enterprise's IT environment, it is common to use different point products purchased from multiple and/or single vendors to manage IT resources from different aspects, such as performance and availability management, change and vulnerability management and/or security event management. It is also common that different point products from different vendors, or even from a single vendor, use different representations for a same IT resource. For example, to represent a same computer object, one point product may use a Fully Qualified Domain Name (FQDN), and another point product may use the FQDN combined with some sort of type data.

Furthermore, there is also no defining standard for storage and retrieval of configuration item (CI) data within a configuration management database (CMDB). Thus, customers in an enterprise IT environment have no means for integrating or leveraging multiple CMDBs from different vendors without substantial custom development by in-house staff or professional services engagements through systems integrators.

In an Information Technology (IT) environment, products can be found that are geared to element management, both by using host based or proxy based agents and also Manager of Managers, which mostly subscribe to event and data from element management applications. It is easy for the administrator of these manager of mangers products to be unaware that specific data or events needed by the product are not available, which could possibly lead to false positive or inaccurate information.

### SUMMARY OF THE INVENTION

Embodiments of the present invention provide methods for retrieval of management information related to a computer network using an object-oriented information model. A plurality of resource classes are provided, instances of which represent a resource on the computer network. Ones of the classes have respective associated attributes. A plurality of association classes are also provided, instances of which represent a relationship between ones of the resource class instances. A query for retrieval of management information is received from a user. The query includes an identification of a first one of the resource classes and a second one of the resource classes and a selected one of the association classes. Instances of the first and/or second ones of the resource classes identified by instances of the selected one of the association classes are retrieved responsive to the received query and an identification of the retrieved instances of the first and/or second ones of the resource classes is provided to the user.

In other embodiments, the first one of the resource classes is a target class and the second one of the resource classes is a clue class instance. The identification of the second one of the resource classes includes an identification of an instance of the second one of the resource classes as the clue class instance. Retrieving instances includes retrieving instances of the target class identified by instances of the selected one of the association classes that also identify the clue class instance. The target class may be a computer network hardware class, instances of which correspond to physical devices. The second one of the resource classes may be a computer network logical unit class, instances of which correspond to a logical unit defined for the computer network. For example, the target class may be computer and the second one of the resource classes may be geographical location, organization unit and/or particular service.

In further embodiments, the received query includes an identification of a plurality of clue class instances and/or an identification of a plurality of different selected ones of the association classes. Retrieving instances of the target class includes retrieving the instances of the target class based on the identified plurality of clue class instances and/or selected ones of the association classes. Retrieving instances may include identifying a subset of instances of the target class for each of the plurality of clue class instances and retrieving instances of the target class corresponding to an intersection of the subsets of instances of the target class. The received query may include an identification of a plurality of clue class instances and an identification of a plurality of different selected ones of the association classes associated with respective ones of the plurality of clue class instances and retrieving instances may include retrieving instances of the target class based on the plurality of clue class instances and their respective ones of the different selected ones of the clue class instances. The identified selected one of the association classes may be, for example, Belong.

In other embodiments, the clue class instance is a first clue class instance and the identification of an instance of the second one of the resource classes as the clue class instance includes an identification of a first instance of the second one of the resource classes as the first clue class instance and a second instance of the second one of the resource classes as a second clue class instance. Retrieving instances of the target class includes retrieving instances of the target class identified both by instances of the selected one of the association classes that also identify the first clue class instance and by instances of the selected one of the association classes that also identify the second clue class instance. The second one of the resource classes may be a plurality of different resources classes and the first clue class instance and the second clue class instance may be instances of different resource classes.

In further embodiments, the received query includes an identification of a plurality of selected ones of the association classes and retrieving instances includes retrieving instances of the target class identified by instances of the plurality of selected ones of the association classes that also identify the clue class instance responsive to the received query. The selected ones of the association classes may include a relational operation coupling a first and second one of the selected ones of the association classes. Retrieving instances may include retrieving instances of the target class identified by instances of both the first one of the selected ones of the association classes and the second one of the selected ones of the association classes responsive to the received query when the relation operation comprises an AND and retrieving instances of the target class identified by instances of either the first one of the selected ones of the association classes or the second one of the selected ones of the association classes responsive to the received query when the relation operation comprises an OR.

In other embodiments, the clue class instance is a plurality of different clue class instances, ones of which are associated with respective ones of the selected ones of the association classes. Retrieving instances of the target class includes retrieving the instances of the target class based on the plurality of different clue class instances and the respective corresponding ones of the selected ones of the association classes. The target class may be a computer network hardware class, instances of which correspond to physical devices and the clue class instances may include an instance of a computer network logical unit class, instances of which correspond to a logical unit defined for the computer network.

In yet further embodiments, the selected one of the association classes represents a relationship of the target class to the second one of the resource classes that is not specified by any of the associated attributes of the target class. Providing a plurality of resource classes may include providing a plurality of predetermined resource classes having fixed respective associated attributes. Providing a plurality of resource classes may be followed by identifying a relationship between an instance of a first one of the predetermined resource classes and an instance of a second one of the predetermined resource classes. One of the plurality of association classes corresponding to the identified relationship is identified. An instance of the identified one of the plurality of association classes is created including an identification of the instance of the first one of the predetermined resource classes and an identification of the instance of a second one of the predetermined resource classes.

In other embodiments, associative information retrieval systems are provided for retrieval of management information related to a computer network using an object-oriented information model. The systems include a plurality of resource classes, instances of which represent a resource on the computer network, ones of the classes having respective associated attributes, and a plurality of association classes, instances of which represent a relationship between ones of the resource class instances. An input module is provided that is configured to receive a query for retrieval of management information from a user, the query including an identification of a first one of the resource classes and a second one of the resource classes and a selected one of the association classes. A retrieval module is provided that is configured to retrieve instances of the first and/or second ones of the resource classes identified by instances of the selected one of the association classes responsive to the received query. A report module is provided that is configured to provide an identification of the retrieved instances of the first and/or second ones of the resource classes to the user. The first one of the resource classes may be a target class and the second one of the resource classes may be a clue class instance and the received identification of the second one of the resource classes may include an identification of an instance of the second one of the resource classes as the clue class instance and the retrieval module may be configured to retrieve instances of the target class identified by instances of the selected one of the association classes that also identify the clue class instance.

### BRIEF DESCRIPTION OF THE DRAWINGS

FIG. 1 is a block diagram of a hardware and software environment in which the present invention may operate according to some embodiments of the present invention.

FIG. 2 is a block diagram of a data processing system according to some embodiments of the present invention.

FIG. 3 is a more detailed block diagram of a data processing system for use in retrieval of management information related to a computer network using an object-oriented information model according to some embodiments of the present invention.

FIGS. 4-5 are flowcharts illustrating operations for retrieval of management information related to a computer network using an object-oriented information model according to some embodiments of the present invention.

### DESCRIPTION OF EMBODIMENTS OF THE PRESENT INVENTION

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements tliroughout. As used herein, the temm “and/or” includes any and all combinations of one or more of the associated listed items.

The tenninology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

As will be appreciated by one of skill in the art, the present invention may be embodied as a method, data processing system, or computer program product. Accordingly, the present invention may take the form of an entirely hardware embodiment, an entirely software embodiment or an embodiment combining software and hardware aspects all generally referred to herein as a “circuit” or “module.” Furthermore, the present invention may take the form of a computer program product on a computer usable storage medium having computer-usable program code means embodied in the medium. Any suitable computer readable medium may be utilized including hard disks, CD-ROMs, optical storage devices, a transmission media such as those supporting the Internet or an intranet, or magnetic storage devices.

Computer program code for carrying out operations of the present invention may be written in an object oriented programming language such as Java® or C++. However, the computer program code for carrying out operations of the present invention may also be written in conventional procedural programming languages, such as the “C” programming language or assembly language. The program code may execute entirely on the user's computer, partly on the user's computer, as a stand alone software package, partly on the user's computer and partly on a remote computer, or entirely on the remote computer. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may also be stored in a computer-readable memory that can direct a computer or other programmable data processing apparatus to operate in a particular manner, such that the instructions stored in the computer-readable memory produce an article of manufacture including instruction means which implement the acts specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the acts specified in the flowchart and/or block diagram block or blocks.

Associations may be viewed syntactically as objects with references to two associated objects and those associated objects are not affected by the existence of associations that refer to them. In other words, multiple associations can be defined for different semantics while utilizing the same pair of associates. As associations are being defined, the same object may play different roles in different semantic scenarios.

As common information models become semantically rich, clients, such as humans or computer programs, of common information models, may need a generic and efficient query mechanism to retrieve objects in a single given semantic scenario or multiple semantics scenarios. For example, in a common information model, a computer object can be associated with an aggregate function/service object playing the semantic role of “computer used in service”. The same computer can be associated with a geographical group object playing the semantic role of “computer located in a geographical location.” A client of the common information model must typically be able to retrieve computer objects by specifying either or both of the semantic scenarios. That is, a client must typically be able to retrieve computers by specifying an aggregate function object and the “computer used in service” association, and a client must typically be able to retrieve computers by specifying a geographical group object and the “computer located in a geographical location” association. Furthermore, a client must typically be able to retrieve computers by specifying an aggregate function object and the “computer used in service” association and a geographical location object and the “computer located in a geographical location” association.

Some embodiments of the present invention provide methods, systems and computer program products that may allow management products to truly and fully utilize the rich management semantics of the information models. In particular, in some embodiments of the present invention provide a query language, for example, using NetIQ Query Language (NQL), that is based on the concept of associative memory retrieval. In the associative memory retrieval paradigm, one recalls, recollects and remembers a set of objects when given one or more clues, hints or suggestions. The more vague the suggestions, the less specific the objects recollected. The more clear the suggestions, the more specific the objects recollected. Based on this paradigm, NQL allows common information model clients to define queries by specifying one or more associative clues that lead to the recollection of instances of a target object class. Each associative clue consists of a single object instance or a set of object instances (the clue objects), and an association with associates as the clue objects and the instances of the target class. Based on an associative clue, a subset of the instances of the target object class is retrieved by traversing the association. The result of a query with multiple associative clues is the intersection of those subsets. For example, the following query finds all computers that belong to the Texas location and used by some organization units.
SELECT
[IQAM_ManagementGroup=US]. [IQAM_ManagementGroup=TX]. [IQAM_ManagementGroup].children}ON COLUMNS Following IQCIM_Belong {[IQAM_OU].members} ON ROWS Following IQCIM_Belong
FROM IQAM_Computer

In this example, the “IQAM_Computer” is the target object class and there are two associative clues. One specifies all management groups under the Texas management group as clue objects, and the other specifies all organization units as clue objects, and both associative clues use the IQCIM_Belong association. A sample output of this query is a two dimensional table as illustrated in Table 1 set out below.

TABLE 1

| | /IQAM_ManagementGroup=Houston | /IQAM_ManagementGroup=Dallas |
|---|---|---|
| /IQAM_OU=Finance | {/IQAM_Computer=houserv01, | {/IQAM_Computer=dalserv01, |
| | /IQAM_Computer=houserv02, | /IQAM_Computer=dalserver02, |
| | /IQAM_Computer=txserv01} | /IQAM_Computer=txserver01} |
| /IQAM_OU=R&D | {/IQAM_Computer=houdepot01} | {/IQAM_Computer=daldepot02} |
| /IQAM_OU=R&D/IQAM_OU=Dev | {/IQAM_Computer=houpuriflicserv} | { } |

The information provided in Table 1 may be useful, for example, in answering questions such as:
If a given computer is down, which organization units would be impacted?
What are the computers that are used for a particular service in a given geographical location?

### It will be understood that these questions are provided for exemplary purposes only and that embodiments of the present invention are not limited thereby.

Accordingly, unlike CQL, which relies on the instance projection and complex object joining paradigm as in relational database queries, queries according to some embodiments of the present invention may be more intuitive to humans and easier to write. Instead of thinking in concepts of relational projections and joins, a human constructs queries according to some embodiments of the present invention by, for example, following threads of thoughts represented by associations. Furthermore, multiple associative clues may serve as multiple dynamic “indexes” to the target object class, and may enable efficient selection of instances of the target object classes without visiting each of those instances. This advantage may become significant when a common information model represents a large number of object instances. It will be understood that queries according to some embodiments of the present invention can involve single and/or multiple association chains without departing from the scope of the present invention.

Accordingly, as common information models play more important roles in management products, methods, systems and computer program products according to some embodiments of the present invention may provide intuitive ways for users to define queries without writing procedural code or having to learn the instance projection and complex object joining techniques. Thus, management products that incorporate the teachings of some embodiments of the present invention may use common information models and allow a user to define queries traversing multiple associations without using the concepts of instance projection and complex object joining.

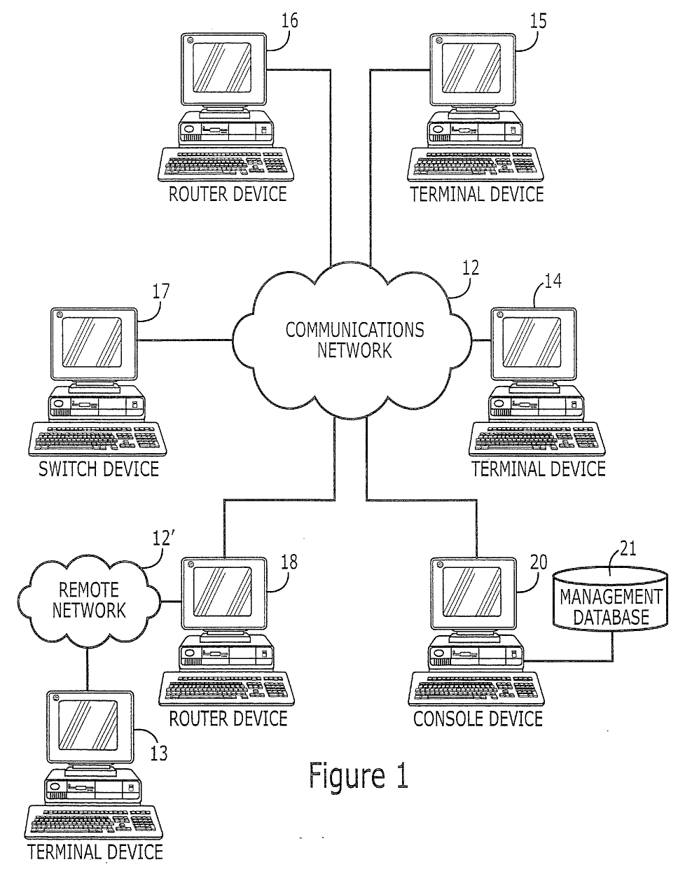

Some embodiments of the present invention will now be described with respect to FIGS. 1 through 5 below. Embodiments of the present invention provide methods, systems and computer program products for retrieval of management information related to a computer network using an object-oriented information model.

Referring first to FIG. 1, a computer network and system for retrieval of management information related to a computer network using an object-oriented information model according to some embodiments of the present invention will be further described. A hardware and software computer network on which the present invention can operate as shown in FIG. 1 will now be described. As shown in FIG. 1, a communications network 12 includes and provides a communication link between terminal devices 14, 15, router devices 16, 18, switch device 17 and console device 20. The terminal devices 14, 15 may, for example, support users accessing a variety of hardware and software resources of the computer network. The terminal devices 14, 15 may further provide resources for other users and/or may execute applications or agents of applications providing for monitoring resources on the computer network and providing data from such monitoring to a management information database 21 accessed by an associated information retrieval system of the present invention.

As will be understood by those having skill in the art, a communications network 12 may include of a plurality of separate linked physical communication networks, which, using a protocol such as the Internet protocol (IP), may appear to be a single seamless communications network to user application programs. For example, as illustrated in FIG. 1, remote network 12′ and communications network 12 may both include a communication node through a port of the router device 18. Accordingly, additional terminal devices or router/switch devices (not shown) or a terminal device 13 on remote network 12′ may be part of the computer network and made available for communications from devices on communications network 12. For some embodiments of the present invention, the network to be evaluated may be limited to the local and/or wide area network of a company or the like.

It is further to be understood that, while for illustration purposes in FIG. 1 communications network 12 is shown as a single network, it may be comprised of a plurality of separate interconnected physical networks, one or more of which may be managed according to some embodiments of the present invention. As illustrated in FIG. 1, the devices 13, 14, 15, 16, 17, 18, 20, 21 may reside on a computer. As illustrated by router device 18, a single computer may be coupled to multiple networks (12, 12′).

Console node 20, or other means for retrieving management information for the computer network may obtain user input, for example, by keyed input to a computer terminal or tlrough a passive monitor, to request and/or provide an information query and may be configured to provide operations as more fully described later herein. The console node 20 is shown as directly coupled to the management information database 21 containing information about managed resources. However, the console device 20 may be coupled to the management information database 21, for example, over the communications network 12.

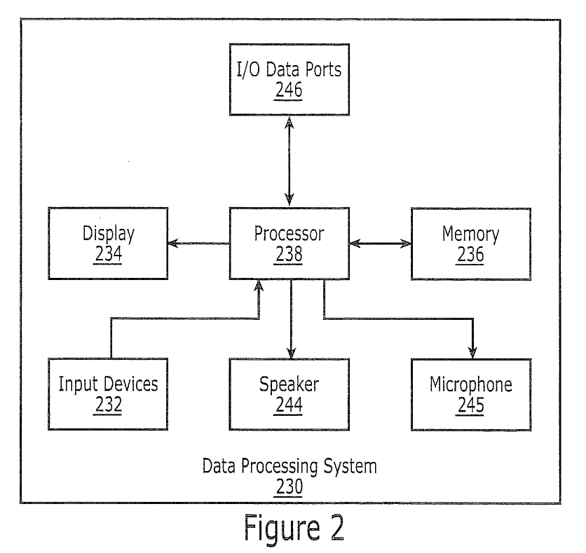

FIG. 2 illustrates an exemplary embodiment of a data processing system 230 in accordance with some embodiments of the present invention. The data processing system 230 typically includes input device(s) 232, such as a keyboard or keypad, a display 234, and a memory 236 that communicate with a processor 238. The data processing system 230 may further include a speaker 244, a microphone 245 and I/O data port(s) 246 that also communicate with the processor 238. The I/O data ports 246 can be used to transfer information between the data processing system 230 and another computer system or a network 12, for example, using an internet protocol (IP) connection. These components may be conventional components, such as those used in many conventional data processing systems, which may be configured to operate as described herein.

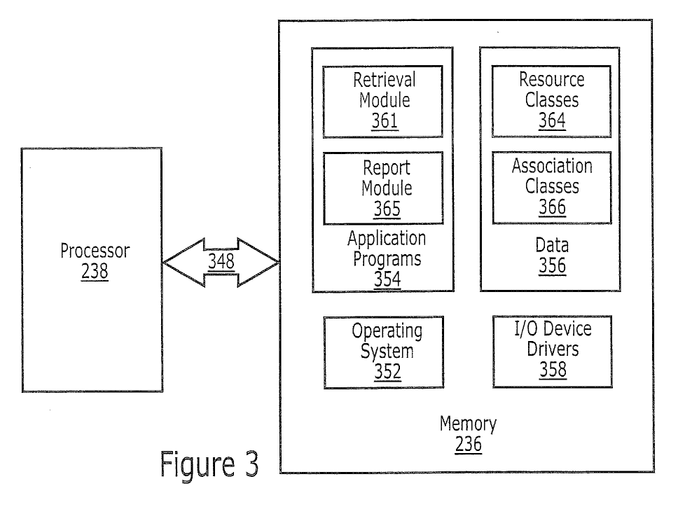

FIG. 3 is a block diagram of a data processing system that illustrates methods, systems and computer program products for retrieval of management information related to a computer network using an object-oriented information model in accordance with some embodiments of the present invention. The processor 238 communicates with the memory 236 via an address/data bus 348. The processor 238 can be any commercially available or custom microprocessor. The memory 236 is representative of the overall hierarchy of memory devices containing the software and data used to implement the functionality of the data processing system 230. The memory 236 can include, but is not limited to, the following types of devices: cache, ROM, PROM, EPROM, EEPROM, flash memory, SRAM, and DRAM.

As shown in FIG. 3, the memory 236 may include several categories of software and data used in the data processing system 230: the operating system 352; the application programs 354; the input/output (I/O) device drivers 358; and the data 356. As will be appreciated by those of skill in the art, the operating system 352 may be any operating system suitable for use with a data processing system, such as Solaris from Sun Microsystems, OS/2, AIX or System390 from International Business Machines Corporation, Armonk, N.Y., Windows95, Windows98, Windows NT, Windows ME, Windows XP or Windows2000 from Microsoft Corporation, Redmond, Wash., Unix or Linux. The I/O device drivers 358 typically include software routines accessed through the operating system 352 by the application programs 354 to communicate with devices such as the input devices 232, the display 234, the speaker 244, the microphone 245, the I/O data port(s) 246, and certain memory 236 components. The application programs 354 are illustrative of the programs that implement the various features of the data processing system 230 and preferably include at least one application that supports operations according to embodiments of the present invention. Finally, the data 356 represents the static and dynamic data used by the application programs 354, the operating system 352, the I/O device drivers 358, and other software programs that may reside in the memory 236.

It will be understood that FIG. 3 illustrates a block diagram of data processing systems implementing a control device (console node) and/or other device for retrieval of management information related to a computer network using an object-oriented information model according to some embodiments of the present invention. Thus, the application programs 354 and the data 356 discussed with respect to FIG. 3 may be located in the console device 20 although it may also be implemented on another device, which may or may not be coupled to the computer network including the communications network 12 to be evaluated, so long as it may communicate with the database or databases containing management information to be accessed.

As illustrated in the embodiments of FIG. 3, the application programs 354 may include a retrieval module 361 and a user report generating module 365. The I/O device drivers 358 and I/O data ports 246 may be configured to provide a communication interface coupled to the network 12 that is configured to receive a query for retrieval of management information from a user. The query may include an identification of resource classes and association classes as will be described further herein.

The data 356 illustrated in the embodiments of FIG. 3 includes resource class data 364 and association class data 366, which may be utilized by the application programs 354 in accordance with various embodiments of the present invention. It will be further understood that the data 365 as described herein may be resident in the management information database 21 illustrated in FIG. 1. The resource class data 364 contains information regarding a plurality of resource classes, instances of which represent a resource on the computer network. Ones of the classes have respective associated attributes. The association class data 366 includes a plurality of association classes, instances of which represent a relationship between ones of the resource class instances. Thus, it will be understood that the resource class data 364 may include records generally defining types of resource classes and their respective attributes as well as specific instances of such resource classes that represent managed resources on the network. Similarly, both information defining association classes and instances of specific association classes are provided in the association class data 366.

Referring again to the application programs 354, the retrieval module 361 is configured to retrieve instances of a target resource class identified by instances of a selected one or more of the association classes responsive to a received query for retrieval of management information. Thus, a received query may include one of the resource classes as a target class and one or more of the resource classes as class instances. The retrieval module 361 may be configured to retrieve instances of the target class identified by instances of the selected one or more of the association classes that also identify the clue class instance or instances, depending upon the query received from a user. The report module 365 is configured to provide an identification of the retrieved instances of the target class to a requesting user.

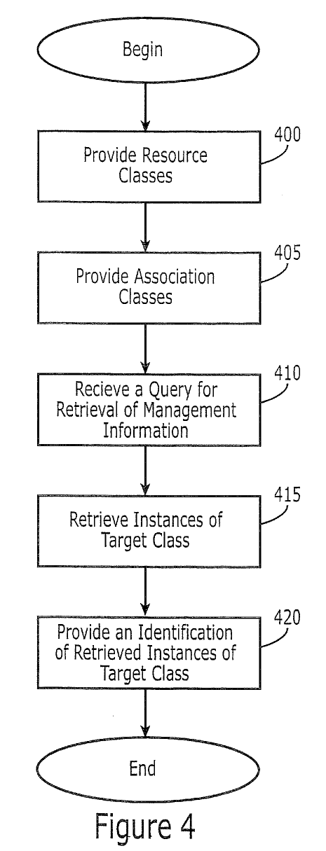

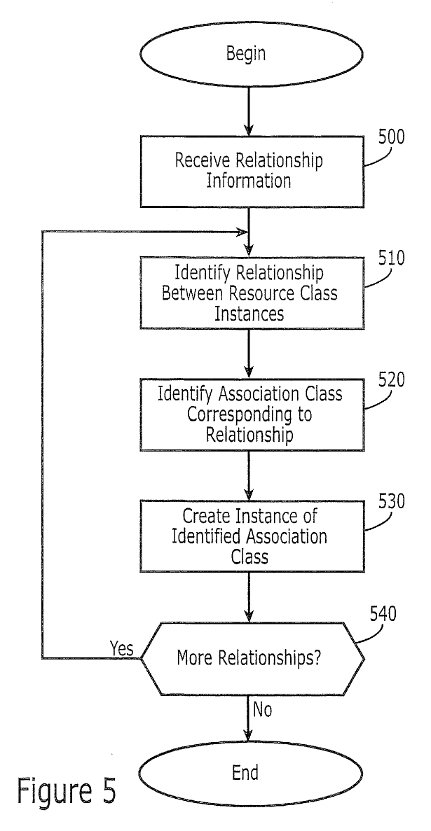

Operations for providing invariant representations according to some embodiments of the present invention will now be further described with reference to the flowchart illustrations of FIGS. 4 through 5. Referring first to FIG. 4, operations begin at block 400 by providing a plurality of resource classes, instances of which represent a resource on the computer network. Ones of the classes have respective associated attributes, which may vary between classes. A plurality of association classes are also provided, instances of which represent a relationship between ones of the resource class instances (block 405). For example, an association class may be the class “Belong” and an instance of the association class “Belong” would record that an instance of one resource class, such as a marketing supervisor's computer (class “Computer”), belongs to an instance of another resource class, such as the marketing group instance of the “Group” class.

A query for retrieval of management information is received from a user (block 410). The query may include an identification of a first one of the resource classes and a second one of the resource classes and a selected one of the association classes. For example, the first one of the resources classes may be a target class and the second one of the resource classes may be a clue class instance. Thus, for example, the target class may comprise a computer network hardware class, instances of which correspond to physical devices, and the clue class instance(s) may comprise instance(s) of a second resource class defining a computer logical unit class, instances of which correspond to a logical unit defined for the computer network (geographical location, organization unit, particular service and/or the like).

Instances of the target class are retrieved that are identified by instances of the selected one of the association classes responsive to the received query (block 415). In some embodiments, retrieving instances at block 415 may include retrieving instances of a designated target class identified by instances of a selected one of the association classes that also identify the clue class instance. It will be understood that a received query at block 410 may include an identification of a plurality of clue class instances and/or an identification of a plurality of different selected ones of the association classes and operations at block 415 may include retrieving instances of the target class based on the identified plurality of clue class instances and/or selected ones of the association classes. In some embodiments, operations for retrieving instances of the target class at block 415 may include identifying a subset of instances of the target class for each of the plurality of clue class instances and retrieving instances of the target class corresponding to an intersection of the subsets of instances of the target class. Where a plurality of associations are provided, operations in retrieving instances of the target class at block 415 may include retrieving instances of the target class based on the plurality of clue class instances and their respective ones of the different selected ones of the clue class instances.

Where multiple clue class instances are provided, retrieving instances of the target class may include retrieving instances of the target class identified both by instances of the selected association class or classes that also identify the first clue class instance and by instances of respective ones of the association classes that also identify the second clue class instance. Note that the association class for each of the clue class instances may be the same or different and/or the clue class instances may similarly be instances of the same and/or different resource class.

In some embodiments of the present invention, the designated selected one of the association classes for a query includes a relational operation coupling first and second ones of the selected ones of the association classes in a more complex query. As such, in some embodiments of the present invention, retrieving instances of the target class identified by instances of the both a first one of the selected association classes and a second one of the association classes responsive to a received query when the relation operation comprises an AND. Instances of the target class identified by instances of either the first one of the association classes or the second one of the association classes are retrieved responsive to the received query when the relational operation comprises an OR. Thus, Boolean logic may be used in structuring queries linking clue instances by respective association classes. As a result, instances of a target class may be retrieved based on a plurality of different clue class instances and respective corresponding ones of the selected association classes.

Further embodiments of the present invention will now be described with reference to the flowchart illustration of FIG. 5. More particularly, the embodiments illustrated in FIG. 5 relate to operations for providing instances of the association classes according to some embodiments of the present invention. In particular, association class instances may be generated to provide class instance association information not available based on the predefined attributes for respective ones of the resource classes. Thus, systems according to some embodiments of the present invention may develop progressively greater knowledge information regarding relationships and associations between class instances of managed resources on a network, which information may be used to allow retrieval of management information by a user in a more intuitive manner. Such an approach may provide for easier and more effective utilization of management information by IT support staff and the like in maintaining operation and service levels on a managed computer network.

Referring now to FIG. 5, for the illustrated embodiments, operations begin by receiving information about one or more instances of respective resources classes, which information may be used to develop knowledge as to associations therebetween (block 500). A relationship between an instance of a first one of the predetermined resource classes and an instance of a second one of the predetermined resource classes is identified (block 510). One of a plurality of available association classes corresponding to the identified relationship is identified (block 520). An instance of the identified one of the plurality of association classes is created, which instance includes an identification of the instance of the first one of the predetermined resource classes and an identification of the instance of the second one of the predetermined resource classes (block 530). If more associational relationships may be generated based on the information received at block 300 (block 540), operations return to block 510 and the operations at blocks 510-530 are repeated.

As described above, some embodiments of the present invention provide for associative retrieval of management information that may be implemented without the use of a complex object joining. In particular, associative retrieval in accordance with some embodiments of the present invention requires no assumptions about relationships and attributes of predefined resource classes in construction of searches as associations may be defined after the classes have been established. Furthermore, the association definitions, in some embodiments, may further be defined and developed dynamically during use. In addition, the search query structures, rather than being worded based on terminology associated with predefined attributes of particular resource classes, may be structured in a more intuitive relationship based format, where association classes may be defined corresponding to such intuitive relationships. For example, a user may wish to get a list of computers used in a Houston office. Both computer and location may be defined resource classes under the common information model and a learned association may be provided as an instance of an association class “located at.”

It will be understood that the block diagrams of FIGS. 1-3 and combinations of blocks in the block diagrams may be implemented using discrete and integrated electronic circuits. It will also be appreciated that blocks of the block diagrams of FIGS. 1-3 and combinations of blocks in the block diagrams may be implemented using components other than those illustrated in FIGS. 1-3, and that, in general, various blocks of the block diagrams and combinations of blocks in the block diagrams, may be implemented in special purpose hardware such as discrete analog and/or digital circuitry, combinations of integrated circuits or one or more application specific integrated circuits (ASICs).

Accordingly, blocks of the block diagrams of FIGS. 1-3 and the flowcharts of FIGS. 4-5 support electronic circuits and other means for performing the specified operations, as well as combinations of operations. It will be understood that the circuits and other means supported by each block and combinations of blocks can be implemented by special purpose hardware, software or firmware operating on special or general purpose data processors, or combinations thereof. It should also be noted that, in some implementations, the operations noted in the blocks may occur out of the order noted in the figures. For example, two blocks shown in succession may, in fact, be executed substantially concurrently, or the blocks may sometimes be executed in the reverse order.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

That which is claimed:

1. A method for retrieval of management information related to a computer network using an object-oriented information model, comprising:
providing a plurality of resource classes, instances of which represent a resource on the computer network, ones of the classes having respective associated attributes;
providing a plurality of association classes, instances of which represent a relationship between ones of the resource class instances;
receiving a query for retrieval of management information from a user, the query including an identification of a first one of the resource classes and a second one of the resource classes and a selected one of the association classes;
retrieving instances of the first and/or second ones of the resource classes identified by instances of the selected one of the association classes responsive to the received query; and
providing an identification of the retrieved instances of the first and/or second ones of the resource classes to the user.

2. The method of claim 1, wherein the first one of the resource classes comprises a target class and the second one of the resource classes comprises a clue class instance and wherein the identification of the second one of the resource classes comprises an identification of an instance of the second one of the resource classes as the clue class instance and wherein retrieving instances comprises retrieving instances of the target class identified by instances of the selected one of the association classes that also identify the clue class instance.

3. The method of claim 2, wherein the target class comprises a computer network hardware class, instances of which correspond to physical devices and wherein the second one of the resource classes comprises a computer network logical unit class, instances of which correspond to a logical unit defined for the computer network.

4. The method of claim 3, wherein the target class comprises computer and wherein the second one of the resource classes comprises geographical location, organization unit and/or particular service.

5. The method of claim 3, wherein the received query includes an identification of a plurality of clue class instances and/or an identification of a plurality of different selected ones of the association classes and wherein retrieving instances of the target class includes retrieving the instances of the target class based on the identified plurality of clue class instances and/or selected ones of the association classes.

6. The method of claim 5, wherein retrieving instances includes identifying a subset of instances of the target class for each of the plurality of clue class instances and retrieving instances of the target class corresponding to an intersection of the subsets of instances of the target class.

7. The method of claim 5, wherein the received query includes an identification of a plurality of clue class instances and an identification of a plurality of different selected ones of the association classes associated with respective ones of the plurality of clue class instances and wherein retrieving instances includes retrieving instances of the target class based on the plurality of clue class instances and their respective ones of the different selected ones of the clue class instances.

8. The method of claim 5, wherein the identified selected one of the association classes comprises Belong.

9. The method of claim 2, wherein the clue class instance comprises a first clue class instance and wherein the identification of an instance of the second one of the resource classes as the clue class instance comprises an identification of a first instance of the second one of the resource classes as the first clue class instance and a second instance of the second one of the resource classes as a second clue class instance and wherein retrieving instances of the target class comprises retrieving instances of the target class identified both by instances of the selected one of the association classes that also identify the first clue class instance and by instances of the selected one of the association classes that also identify the second clue class instance.

10. The method of claim 9, wherein the second one of the resource classes comprises a plurality of different resources classes and wherein the first clue class instance and the second clue class instance comprise instances of different resource classes.

11. The method of claim 2, wherein the received query includes an identification of a plurality of selected ones of the association classes and wherein retrieving instances comprises retrieving instances of the target class identified by instances of the plurality of selected ones of the association classes that also identify the clue class instance responsive to the received query.

12. The method of claim 11, wherein the selected ones of the association classes includes a relational operation coupling a first and second one of the selected ones of the association classes and wherein, retrieving instances includes:
retrieving instances of the target class identified by instances of both the first one of the selected ones of the association classes and the second one of the selected ones of the association classes responsive to the received query when the relation operation comprises an AND; and
retrieving instances of the target class identified by instances of either the first one of the selected ones of the association classes or the second one of the selected ones of the association classes responsive to the received query when the relation operation comprises an OR.

13. The method of claim 11, wherein the clue class instance comprises a plurality of different clue class instances, ones of which are associated with respective ones of the selected ones of the association classes, and wherein retrieving instances of the target class includes retrieving the instances of the target class based on the plurality of different clue class instances and the respective corresponding ones of the selected ones of the association classes.

14. The method of claim 13, wherein the target class comprises a computer network hardware class, instances of which correspond to physical devices and wherein the clue class instances include an instance of a computer network logical unit class, instances of which correspond to a logical unit defined for the computer network.

15. The method of claim 2, wherein the selected one of the association classes represents a relationship of the target class to the second one of the resource classes that is not specified by any of the associated attributes of the target class.

16. The method of claim 15, wherein providing a plurality of resource classes comprises providing a plurality of predetermined resource classes having fixed respective associated attributes and wherein providing a plurality of resource classes is followed by:
identifying a relationship between an instance of a first one of the predetermined resource classes and an instance of a second one of the predetermined resource classes;
identifying one of the plurality of association classes corresponding to the identified relationship; and
creating an instance of the identified one of the plurality of association classes including an identification of the instance of the first one of the predetermined resource classes and an identification of the instance of a second one of the predetermined resource classes.

17. A system configured to carry out the method of claim 14.

18. A computer program product for retrieval of management information related to a computer network using an object-oriented information model, the computer program product comprising computer program code embodied in a computer readable medium, the computer program code comprising program code configured to carry out the method of claim 14.

19. An associative information retrieval system for retrieval of management information related to a computer network using an object-oriented information model, comprising:
a plurality of resource classes, instances of which represent a resource on the computer network, ones of the classes having respective associated attributes;
a plurality of association classes, instances of which represent a relationship between ones of the resource class instances;
an input module configured to receive a query for retrieval of management information from a user, the query including an identification of a first one of the resource classes and a second one of the resource classes and a selected one of the association classes;
a retrieval module configured to retrieve instances of the first and/or second ones of the resource classes identified by instances of the selected one of the association classes responsive to the received query; and
a report module configured to provide an identification of the retrieved instances of the first and/or second ones of the resource classes to the use.

20. The system of claim 19, wherein the first one of the resource classes comprises a target class and the second one of the resource classes comprises a clue class instance and wherein the received identification of the second one of the resource classes comprises an identification of an instance of the second one of the resource classes as the clue class instance and wherein the retrieval module is configured to retrieve instances of the target class identified by instances of the selected one of the association classes that also identify the clue class instance.

21. A computer program product for retrieval of management information related to a computer network using an object-oriented information model, the computer program product comprising:
a computer-readable storage medium having computer-readable program code embodied in said medium, said computer-readable program code comprising:
a plurality of resource classes, instances of which represent a resource on the computer network, ones of the classes having respective associated attributes;
a plurality of association classes, instances of which represent a relationship between ones of the resource class instances;
computer-readable program code that receives a query for retrieval of management information from a user, the query including an identification of a first one of the resource classes and a second one of the resource classes and a selected one of the association classes;
computer-readable program code that retrieves instances of the first and/or second ones of the resource classes identified by instances of the selected one of the association classes responsive to the received query; and
computer-readable program code that provides an identification of the retrieved instances of the first and/or second ones of the resource classes to the user.
